(19) United States
(12) Patent Application Publication
(10) Pub. No.: US 2025/0132531 A1
(43) Pub. Date: Apr. 24, 2025

(54) CONTACT INSERT FOR AN INDUSTRIAL CONNECTOR

(71) Applicant: Phoenix Contact GmbH & Co.KG, Blomberg (DE)

(72) Inventor: Manuel TÜNKER, Dörentrup (DE)

(21) Appl. No.: 18/923,726

(22) Filed: Oct. 23, 2024

(30) Foreign Application Priority Data
Oct. 24, 2023 (DE) 102023129143.2

(51) Int. Cl. H01R 25/16; H01R 4/48; H01R 13/04

(52) U.S. Cl. CPC H01R 25/161; H01R 4/485; H01R 13/04

(57) ABSTRACT

A contact insert for an industrial connector includes: an approximately cuboid-shaped insulating body; a plurality of conductor connection elements; and a plurality of contact elements. The contact insert has a connection side and an opposite contact side. On the connection side, a plurality of conductor insertion openings leading to individual conductor connection elements of the plurality of conductor connection elements are formed in the insulating body. The plurality of contact elements are accessible from the contact side for contacting corresponding mating contact elements of a mating contact insert. The contact insert has a potential distribution element via which a contact element of the plurality of contact elements is electrically conductively connected to at least two conductor connection elements of the plurality of conductor connection elements. n conductor insertion openings and n conductor connection elements are provided on the connection side.

### CROSS-REFERENCE TO PRIOR APPLICATION

Priority is claimed to German Patent Application No. DE 102023129143.2, filed on Oct. 24, 2023, the entire disclosure of which is hereby incorporated by reference herein.

### FIELD

The invention relates to a contact insert for an industrial connector, having an approximately cuboid-shaped insulating body, with a plurality of conductor connection elements and with a plurality of contact elements, wherein the contact insert has a connection side and an opposite contact side, and wherein a plurality of conductor insertion openings leading to the individual conductor connection elements are formed on the connection side. The contact elements are accessible from the contact side for contacting corresponding mating contact elements of a mating contact insert.

### BACKGROUND

Contact inserts for industrial connectors, in which a plurality of conductor connection elements and a plurality of contact elements are arranged, are designed to be connected to a corresponding mating contact insert which is arranged in a housing of a mating connector. The individual conductor connection elements are each firmly connected to a contact element, so that a conductor connection element and a contact element form a structural unit. A contact insert therefore has an equal number of conductor connection elements and contact elements.

With the aid of a conductor connection element, the end of a conductor can be connected to the corresponding contact element. Different types of conductor connection elements are known, in particular screw connections, tension spring connections, spring-loaded clamping connections, crimp connections, or cutting connections. The contact elements may in particular be contact pins or contact sockets which are connected to corresponding contact elements of the mating contact insert when the contact insert is plugged together with a corresponding mating contact insert, or the connector is plugged together with the corresponding mating connector.

Generally, contact inserts can be divided into modular contact inserts and fixed-pole contact inserts. Contact inserts in which the number and type of conductor connection elements and contact elements arranged in the insulating body cannot be changed are often referred to as fixed-pole contact inserts, and the connectors containing them are referred to as fixed-pole connectors. The contact inserts are usually fastened to the housing part of the connector by means of screws, for which purpose lateral flange sections with corresponding holes are formed on the contact inserts. To increase flexibility, modular connectors are used in which individual contact inserts, each with only a few conductor connection elements and a few contact elements, are inserted into separate holding frames and fastened therein. Because the contact inserts can be inserted individually into the holding frame, it is possible to equip a holding frame with different contact inserts depending upon the intended use. The fully assembled holding frame, in which the respective modular contact inserts are inserted, can be inserted into a housing part of a connector and fastened, for which purpose the holding frame has a flange section on both of its end faces.

Contact inserts for industrial connectors are designed to be connected to a corresponding mating contact insert of a mating connector. Contact inserts or connectors that are connected to the live side, the supply side, usually have socket contacts as contact elements in order to ensure the required finger contact safety. Contact inserts or connectors that are connected to the consumer side then usually have as contact elements pin contacts which correspond to the socket contacts. The present invention relates to contact inserts intended to be connected to the consumer side.

For the energy transmission of single-phase or multi-phase mains voltages, harmonized CEE plug devices are mostly used in the private, public, and commercial sectors. These are circular plug connectors with a fixed number of contacts. In industrial environments, where data transmission is also important in addition to energy transmission, industrial connectors are often used, which are significantly smaller and also offer various connection options.

### SUMMARY

In an embodiment, the present invention provides a contact insert for an industrial connector, comprising: an approximately cuboid-shaped insulating body: a plurality of conductor connection elements; and a plurality of contact elements, wherein the contact insert has a connection side and an opposite contact side, wherein, on the connection side, a plurality of conductor insertion openings leading to individual conductor connection elements of the plurality of conductor connection elements are formed in the insulating body, wherein the plurality of contact elements are accessible from the contact side for contacting corresponding mating contact elements of a mating contact insert, wherein the contact insert has a potential distribution element via which a contact element of the plurality of contact elements is electrically conductively connected to at least two conductor connection elements of the plurality of conductor connection elements, and wherein n conductor insertion openings and n conductor connection elements are provided on the connection side, and m contact elements are provided on the contact side, where n>m.

### BRIEF DESCRIPTION OF THE DRAWINGS

Subject matter of the present disclosure will be described in even greater detail below based on the exemplary figures. All features described and/or illustrated herein can be used alone or combined in different combinations. The features and advantages of various embodiments will become apparent by reading the following detailed description with reference to the attached drawings, which illustrate the following:

FIG. 1 shows a perspectival view of an exemplary embodiment of a contact insert from the connection side,

FIG. 2 shows a perspectival view of the contact insert according to FIG. 1 from the contact side,

FIG. 3 shows an exploded view of the contact insert according to FIG. 1,

FIGS. 4a-4b show two perspectival views of the potential distribution element of the contact insert with three insulating washers,

FIGS. 5a-5b show two perspectival views of the potential distribution element of the contact insert,

FIGS. 6a-6b show two perspectival views of a mating contact insert corresponding to the contact insert,

FIG. 7 shows a perspectival view of an industrial connector with a contact insert from the contact side, and

FIG. 8 shows a perspectival view of an industrial connector corresponding to the industrial connector according to FIG. 7.

### DETAILED DESCRIPTION

In an embodiment, the present invention further increases the possible uses of a contact insert for industrial connectors as described above.

In an embodiment, the contact insert according to the present invention has a potential distribution element via which a contact element is electrically conductively connected to at least two conductor connection elements, and in that n conductor insertion openings and n conductor connection elements are provided on the connection side, and m contact elements are provided on the contact side, where n>m. The contact insert thus has more conductor connection elements than contact elements, since a contact element is electrically conductively connected to at least two conductor connection elements via the potential distribution element. This allows the potential applied to a contact element to be distributed across a plurality of conductor connection elements without the need for additional components such as distribution terminals or bridges. The potential distribution element integrated into the contact insert ensures a secure electrical connection between the one contact element and the at least two conductor connection elements, wherein the distribution of large currents is also made possible by appropriate dimensioning of the potential distribution element with correspondingly large cross-sections.

With a contact insert according to the invention, which is used for energy transmission in a multi-phase network, a neutral conductor can be connected to each phase L1, L2, and L3, for example, wherein the conductor connection elements for the neutral conductors are connected via the potential distribution element to the one contact element that is assigned to the neutral conductor.

As previously stated, the contact inserts according to the invention are intended to be connected to the consumer side. The contact elements of the contact insert are therefore preferably designed as pin contacts that can be connected to corresponding socket contacts of a mating contact insert.

According to a preferred embodiment of the contact insert according to the invention, the potential distribution element is preferably designed as a busbar, via which the one contact element is electrically conductively connected to the at least two conductor connection elements. The design of the potential distribution element as a busbar has the advantage that the busbar can be easily punched out as a stamped and bent part from a material with good electrical conductivity, in particular a sheet metal, and can be bent if necessary. In addition, by choosing a sufficiently large cross-section of the busbar, the safe transmission of even large currents via the potential distribution element can be ensured.

Preferably, the busbar has a connecting section and at least two, preferably three, contact sections extending from the connecting section. The contact sections and the connecting section can be formed in one piece or consist of individual elements that are connected to one another in a force-fitting, form-fitting, or material-fitting manner. The contact sections are designed such that they each form at least part of a conductor connection element. The design of the contact sections depends upon how the conductor connection elements are designed. The conductor connection elements can be designed as a spring-loaded clamping connection, a screw connection, a crimp connection, a tension spring connection, a cutting connection, or even a solder connection.

If a conductor connection element is designed as a crimp connection, for example, the end of the contact section forms the crimp contact to which the stripped end of a conductor can be connected. The crimp contact is preferably formed in one piece with the busbar. If a conductor connection element is designed as a screw connection, the end of the contact section forms a current bar section against which the stripped end of a conductor is pressed or pulled by the screw of the screw connection. The end of the contact section then becomes part of the screw connection.

If the conductor connection elements are each designed as a spring-loaded clamping connection, each of which has a clamping spring with a clamping leg and a current bar, which, together with the clamping leg, forms the clamping point for a conductor to be connected, the individual contact sections of the busbar are thus designed such that they each serve as a current bar of a spring-loaded clamping connection. The end of the contact section of a busbar then forms a spring-loaded clamping connection together with a clamping spring.

Even if the individual conductor connection elements of a contact insert can in principle be designed differently, it is preferably provided that all conductor connection elements of a contact insert be designed in the same way, so that a contact insert has a uniform connection technology, which makes it easier for the installer to connect the individual conductors to the contact insert.

The connection of the potential distribution element to the contact element can generally be realized in various ways. According to a preferred embodiment, one contact element is screwed or riveted to the busbar, which makes it easy to create a connection that is electrically highly conductive and mechanically stable.

It was stated at the beginning that the contact insert has an approximately cuboid-shaped insulating body in which the conductor connection elements and the contact elements are arranged. The insulating body can consist of two insulating body halves, whereby the individual conductor connection elements, the contact elements, and also the potential distribution element can be easily positioned in the insulating body halves. The two insulating body halves can be fastened by locking means which are formed on both insulating body halves.

According to a particularly preferred embodiment, however, the insulating body consists of n insulating washers arranged next to one another, wherein at least one conductor connection element is arranged in each of the individual insulating washers, and a conductor insertion opening leading to the respective conductor connection element is formed on the connection side of the individual insulating washers. The individual insulating washers can be at least partially open on the longitudinal side facing an adjacent insulating washer so that the conductor connection element can be easily inserted into the insulating washer.

The insulating washers, the conductor connection elements of which are electrically conductively connected to the potential distribution element, also have a receiving region which serves to receive at least a portion of the potential distribution element. In the other insulating washers, the conductor connection elements of which are not connected to the potential distribution element, a contact element is arranged such that it is accessible from the contact side for contacting a corresponding mating contact element of a mating contact insert.

The connection of the individual insulating washers to the insulating body can be achieved, for example, by locking the individual insulating washers, arranged next to one another, using locking means that correspond to one another. An insulating body mounted in this way can then be inserted directly into a connector housing of an industrial connector.

The individual insulating washers are preferably at least partially received in a frame-like outer housing. The outer housing is preferably also made of an insulating material, but can also be made at least partially of an electrically conductive material. If the contact insert has a frame-like outer housing, on the two opposite end faces of the outer housing, two flange sections are preferably formed, which serve to fix the contact insert in a connector housing of an industrial connector. On the end faces of the outer housing, additional contacting elements can be arranged, via which an electrical connection with a metallic connector housing can be realized.

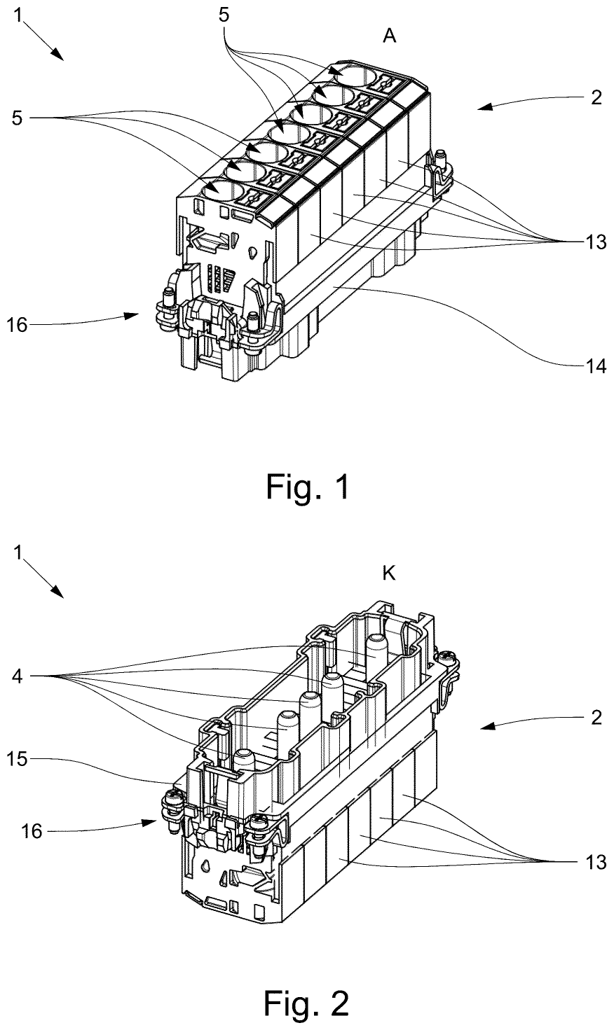

FIG. 1 shows a preferred exemplary embodiment of a contact insert 1 for an industrial connector from the connection side A, and FIG. 2 shows the contact insert 1 from the contact side K. The contact insert 1 has an insulating body 2 in which a plurality of conductor connection elements 3 and a plurality of contact elements 4 are arranged. In addition, in the connection side A of the insulating body 2, a plurality of conductor insertion openings 5 are formed, which lead to the individual conductor connection elements 3, so that a corresponding number of conductors can be connected to the contact insert 1 or to its conductor connection elements 3.

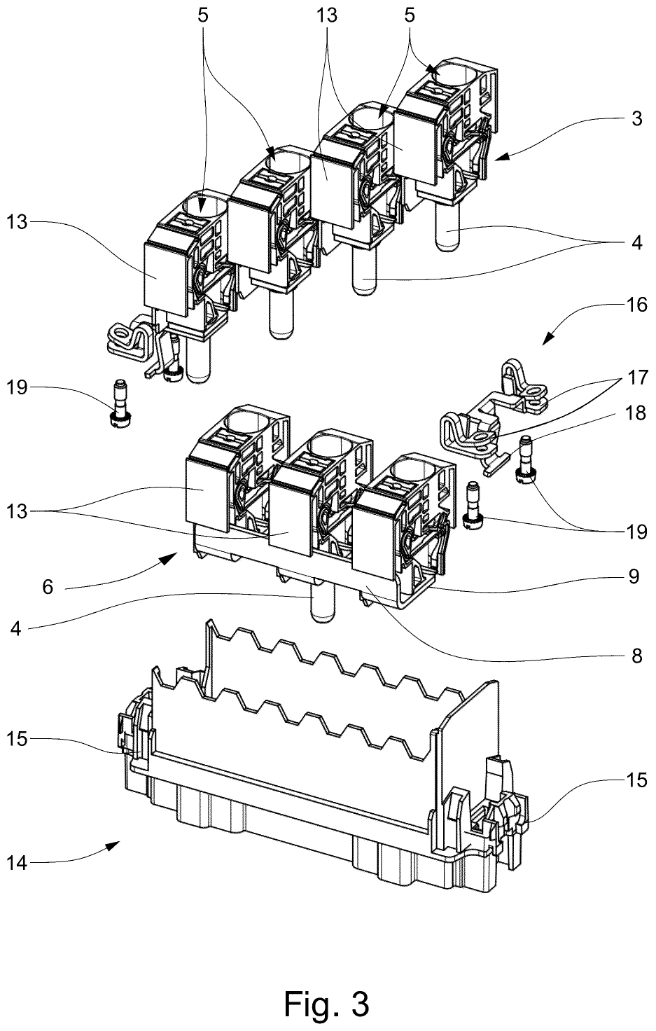

As can be seen in particular from the exploded view according to FIG. 3, the contact insert according to the invention has a potential distribution element 6, via which a contact element 4 is electrically conductively connected to three conductor connection elements 3. Three electrical conductors on the connection side A of the contact insert 1 can thus, via the three conductor connection elements 3, be connected to the one contact element 4 accessible from the contact side K. Since the other conductor connection elements 3 are each connected to a contact element 4, the contact insert 1 shown in the figures has a total of five contact elements 4 on the contact side K and seven conductor connection elements 3, and, correspondingly, seven conductor insertion openings 5 on the connection side A of the contact insert 1.

The contact insert 1 shown in the figures is a 5-pole contact insert intended for energy transmission in a three-phase network with phases L1, L2, L3, an earth conductor PE, and a neutral conductor L. Because the contact insert 1 has the potential distribution element 6, a neutral conductor can also be connected to each phase L1, L2, and L3 on the connection side A, although on the contact side K only one contact element 4 is provided for the neutral potential. Alternatively, the potential distribution element 6 could also be provided for connecting three PE conductors on the connection side A, wherein the contact element 4 electrically connected to the potential distribution element 6 would then be assigned to the PE connection.

Both the number n of conductor connection elements 3 and the number m of contact elements 4 as well as the dimensions of the insulating body 2 may differ from the exemplary embodiment shown. For example, only two conductor connection elements 3 or more than three conductor connection elements 3 could be connected to a contact element 4 via the potential distribution element 6. However, what all possible design variants of the contact insert 1 have in common is that the number n of conductor connection elements 3 is greater than the number m of contact elements 4. As a rule, n=m+2 or n=m+1.

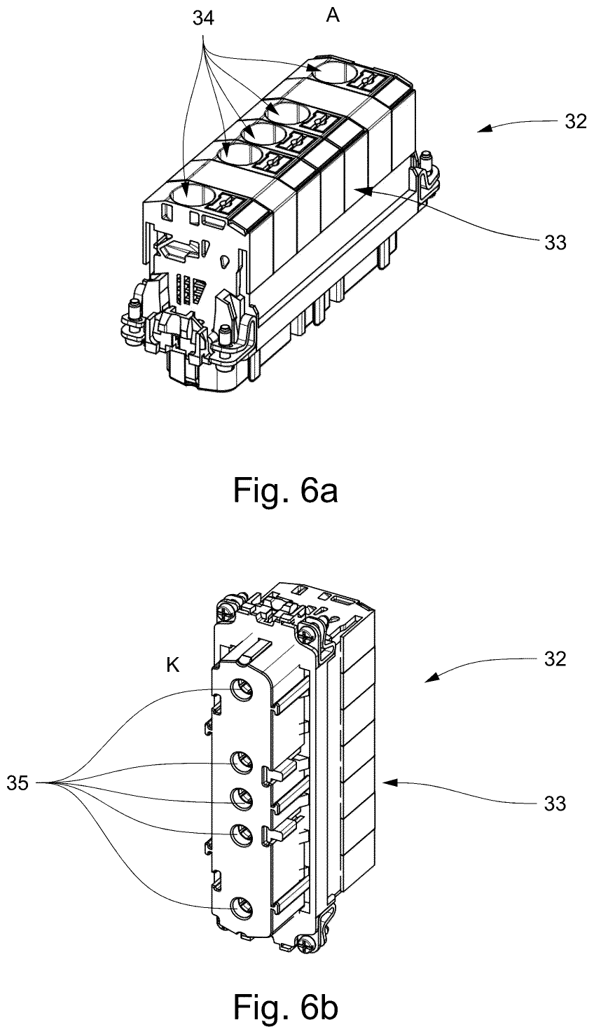

From the representation of the contact insert 1 from the contact side K according to FIG. 2, it can be seen that the individual contact elements 4 are designed as pin contacts. The contact elements 4 thus serve to contact corresponding socket contacts of a mating contact insert, wherein such a mating contact insert (cf. FIG. 6) is connected to the live supply side, while the contact insert 1 according to the invention is arranged on the consumer side, i.e., is provided for connecting conductors to the respective consumer.

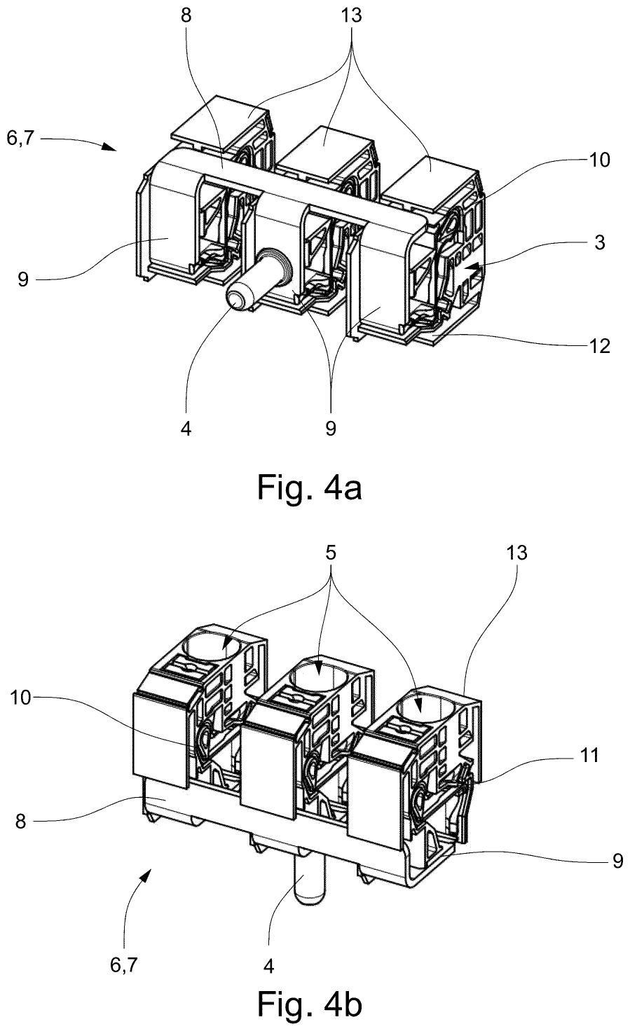

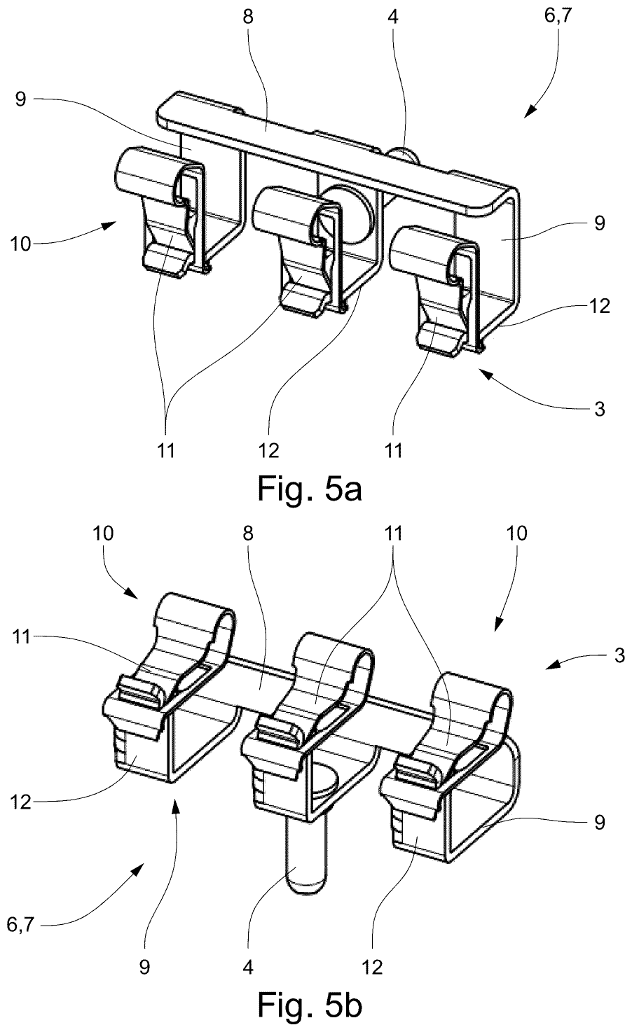

From the exploded view of the contact insert 1 according to FIG. 3 and from FIGS. 4a, 4b and 5a, 5b, it can be seen that the potential distribution element 6 is designed as a busbar 7, via which the one contact element 4 is electrically conductively connected to the three conductor connection elements 3. The busbar 7 has a connecting section 8 and three contact sections 9 which extend from the connecting section 8. Via the connecting section 8, the contact sections 9 are electrically conductively connected to one another and to the contact element 4 that is firmly connected to the busbar 7. The individual contact sections 9 also each form a part of the individual conductor connection elements 3, as can be seen in particular from FIGS. 5a and 5b.

In the exemplary embodiment shown, the conductor connection elements 3 are each designed as a spring-loaded clamping connection, thus each having a clamping spring 10 with a clamping leg 11 and a current bar 12. The individual current bars 12, which together with the clamping leg 11 of a clamping spring 10 form a clamping point for a conductor to be connected, are formed by the free ends of the contact sections 9 of the busbar 7, so that the individual contact sections 9 are each part of the individual spring-loaded clamping connections.

The individual contact element 4 is preferably connected to the busbar 7 by rivets, in particular in the middle region of the busbar 7, in this case in the region of the middle contact section 9. Depending upon the design and shape of the busbar 7 and depending upon the type of conductor connection elements 3, the contact element 4 can also be fastened to a different position on the busbar 7—for example, on the connecting section 8.

In particular, from the exploded view of the contact insert 1 according to FIG. 3, it is also clear that the insulating body 2 is composed of a total of seven insulating washers 13, each of which on its connection side A has a conductor insertion opening 5, which in each case leads to a conductor connection element 3 arranged in the respective insulating washer 13. In the case of the insulating washers 13, the conductor connection elements 3 of which are not connected to a contact element 4 via the potential distribution element 6, in each of the individual insulating washers 13, another contact element 4 is arranged, which, on the contact side K, protrudes from the insulating washer 13.

In addition, the contact insert 1 also has another frame-like outer housing 14, which serves to receive the individual insulating washers 13. The outer housing 14 on each of its two end faces has a flange section 15 for receiving a metallic contacting section 16. The contacting section 16 has two spring-loaded contact sections 17 and a contact tab 18 on the sides. The contacting section 16 and thus also the contact insert 1 can be mechanically fastened in a metallic connector housing 21 via the screws 19. When the contact insert 1 is mounted, the connector housing 21 is also electrically conductively contacted via the spring-loaded contact sections 17. The contact tab 18 serves to electrically contact a mating contact insert 32 arranged in a corresponding connector housing 31 of a second industrial connector 30.

A corresponding mating contact insert 32 with an insulating body 33 is shown in two perspectives in FIGS. 6a and 6b. The mating contact insert 32 has five conductor insertion openings 34 on its connection side A, which lead to five conductor connection elements. On its contact side K, five plug sockets 35 are arranged as contact elements for connection to the contact elements 4 of the contact insert 1 according to FIGS. 1 and 2. The mating contact insert 32 shown is thus intended to be connected on its connection side A via the conductor connection elements to the conductors of the supply side, and on its contact side K to the contact side of the contact insert 1.

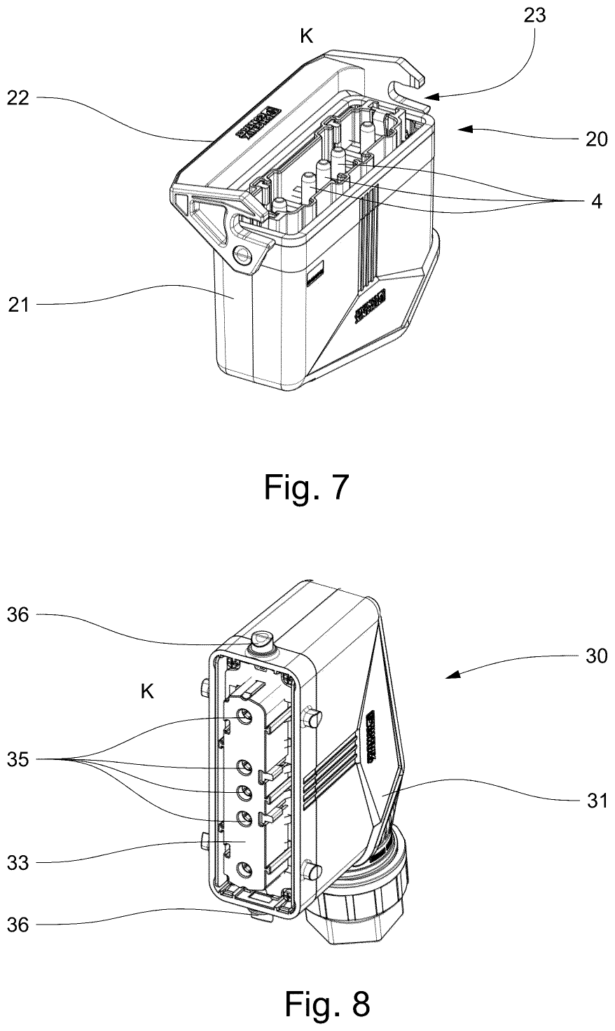

FIG. 7 shows an industrial connector 20 with a contact insert 1 inserted in a connector housing 21, according to FIG. 2, obliquely from the contact side K. FIG. 8 shows a corresponding second industrial connector 30 with a mating contact insert 32 inserted in the connector housing 31, according to FIG. 6b, obliquely laterally from the contact side K, with which the industrial connector 30 can be plugged onto the industrial connector 20 according to FIG. 7. To lock the two industrial connectors 20, 30, a pivotable locking bracket 22 is arranged on the connector housing 21, and two locking pins 36 are arranged on the connector housing 31, which, when locked, are encompassed by the locking openings 23 of the locking bracket 22, so that the two connector housings 21, 31 cannot be separated from one another.

While the invention has been illustrated and described in detail in the drawings and foregoing description, such illustration and description are to be considered illustrative or exemplary and not restrictive. It will be understood that changes and modifications may be made by those of ordinary skill within the scope of the following claims. In particular, the present invention covers further embodiments with any combination of features from different embodiments described above and below. Additionally, statements made herein characterizing the invention refer to an embodiment of the invention and not necessarily all embodiments.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B.” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

REFERENCE SIGNS

| | | | |
|---|---|---|---|
| 1. | Contact insert | 30. | Industrial connector |
| 2. | Insulating body | 31. | Connector housing |
| 3. | Conductor connection element | 32. | Mating contact insert |
| 4. | Contact element | 33. | Insulating body |
| 5. | Conductor insertion opening | 34. | Conductor insertion opening |
| 6. | Potential distribution element | 35. | Plug socket |
| 7. | Busbar | 36. | Locking pin |
| 8. | Connecting section | | |
| 9. | Contact section | | |
| 10. | Clamping spring | | |
| 11. | Clamping leg | | |
| 12. | Current bar | | |
| 13. | Insulating washer | | |
| 14. | Outer housing | | |
| 15. | Flange section | | |
| 16. | Contacting element | | |
| 17. | Contact section | | |
| 18. | Contact tab | | |
| 19. | Screws | | |
| 20. | Industrial connector | | |
| 21. | Connector housing | | |
| 22. | Locking bracket | | |
| 23. | Locking opening | | |
| A | Connection side | | |
| K | Contact side | | |

1. A contact insert for an industrial connector, comprising:
an approximately cuboid-shaped insulating body;
a plurality of conductor connection elements; and
a plurality of contact elements,
wherein the contact insert has a connection side and an opposite contact side,
wherein, on the connection side, a plurality of conductor insertion openings leading to individual conductor connection elements of the plurality of conductor connection elements are formed in the insulating body,
wherein the plurality of contact elements are accessible from the contact side for contacting corresponding mating contact elements of a mating contact insert,
wherein the contact insert has a potential distribution element via which a contact element of the plurality of contact elements is electrically conductively connected to at least two conductor connection elements of the plurality of conductor connection elements, and
wherein n conductor insertion openings and n conductor connection elements are provided on the connection side, and m contact elements are provided on the contact side, where n>m.

2. The contact insert of claim 1, wherein the contact elements comprise pin contacts.

3. The contact insert of claim 1, wherein the individual conductor connection elements comprises at least one of a spring-loaded clamping connection, screw connection, crimp connection, tension spring connection, and a cutting connection.

4. The contact insert of claim 1, wherein the potential distribution element comprises a busbar, via which a respective contact element of the plurality of contact elements is electrically conductively connected to the at least two conductor connection elements.

5. The contact insert of claim 4, wherein the busbar has a connecting section and at least two contact sections extending from the connecting section, and
wherein the at least two contact sections each form at least part of a conductor connection element.

6. The contact insert of claim 5, wherein the conductor connection elements each comprise a spring-loaded clamping connection, each having a clamping spring with a clamping leg and a current bar, which, together with the clamping leg, forms a clamping point for a conductor to be connected, and
wherein the at least two contact sections of the busbar each comprise a current bar of a spring-loaded clamping connection.

7. The contact insert of claim 4, wherein the respective contact element is screwed or riveted to the busbar in a middle region of the busbar.

8. The contact insert of claim 1, wherein the insulating body comprises n insulating washers arranged next to one another,
wherein a respective conductor connection element of the plurality of conductor connection elements is arranged in each insulating washer of the n insulating washers, and a conductor insertion opening leading to the respective conductor connection element is formed on the connection side of each insulating washer.

9. The contact insert of claim 8, wherein each insulating washer is at least partially received in a frame-like outer housing.

10. The contact insert of claim 1, wherein the contact insert comprises seven conductor connection elements and five contact elements,
wherein three conductor connection elements of the seven conductor connection elements are connected to a contact element via the potential distribution element, and
wherein four remaining conductor connection elements of the seven conductor connection elements are each individually electrically conductively connected to a contact element.

11. An industrial connector, comprising:
a connector housing; and
the contact insert of claim 1.

12. The contact insert of claim 5, wherein the at least two contact sections comprise three contact sections.
